(19) United States
(12) Patent Application Publication
(10) Pub. No.: US 2011/0210625 A1
(43) Pub. Date: Sep. 1, 2011

(54) MOTOR GEARBOX UNIT

(75) Inventors: Guenter Kastinger, Gaggenau-Sulzbach (DE); Mario Huesges, Buehlertal (DE); Mike Obert, Gernsbach (DE); Detlef Lauk, Renchen (DE); Klaus Riedinger, Gaggenau (DE)

(73) Assignee: ROBERT BOSCH GMBH, Stuttgart (DE)

(21) Appl. No.: 13/120,269

(22) PCT Filed: Aug. 6, 2009
(86) PCT No.: PCT/EP09/60182

§ 371 Date: May 6, 2011

(30) Foreign Application Priority Data
Sep. 22, 2008 (DE) 102008042250.9

(51) Int. Cl. H02K 7/116; H02K 11/00; H02K 5/22

(52) U.S. Cl. 310/43; 310/83; 310/71

(57) ABSTRACT

The invention relates to a motor gearbox unit (1), particularly for a windshield wiper system in a motor vehicle, comprising an electric motor (12) and a gearbox (14) driven by the electric motor (12), and a housing (2). According to the invention, the housing 2) is designed as a shell housing receiving both the electric motor (12) and the gearbox (14) and comprises a first and a second shell part (3, 4).

### BACKGROUND OF INVENTION

The invention relates to a motor gearbox unit, in particular for a pane wiping assembly in a motor vehicle.

Housings which have previously been used in practice for motor gearbox units for pane wiping assemblies comprise a pole pot of an electric motor, which pole pot is flange connected laterally to a two piece gearbox housing. The complicated mounting and the robustness which is in need of improvement of known housings are disadvantageous.

Furthermore, it is known to use shell housings which are formed from two symmetrical half shells exclusively for electric motors, in which the individual functions such as mounting, positioning and tolerance compensation are divided equally among both shells.

### SUMMARY OF THE INVENTION

The invention is based on the object of proposing a motor gearbox unit of alternative construction. This should preferably be capable of being mounted comparatively simply and adapted universally to application specific requirements. Furthermore, the object comprises proposing a pane wiping assembly with a correspondingly optimized motor gearbox unit.

The invention is based on the concept of providing a common housing, which is configured as a shell housing, for the electric motor and the gearbox of the motor gearbox unit, which gearbox can be driven by the electric motor and is preferably configured as a worm gear mechanism. The mounting of the motor gearbox unit is facilitated considerably and additionally the robustness is increased by the provision of a common housing, which is configured as a shell housing, for the electric motor and the gearbox. Here, there is a very wide variety of possibilities for fixing the two shell parts to one another. One embodiment is particularly preferred, in which the two shell parts are crimped to one another; it is particularly preferred, in order to ensure a sufficient moisture-proof property, to provide a circumferential annular seal between the shell parts, which annular seal is preferably configured as a flat seal.

One embodiment is very particularly preferable, in which the shell parts are not shaped symmetrically with respect to one another, but rather asymmetrically, that is to say not identically. As a result, it is possible for the first time in shell housings to divide the functions of the housing, such as mounting, positioning and tolerance compensation, differently among the two shell parts. This in turn makes it possible to configure the shell parts in an optimum manner, optimized for their respective function. One embodiment is particularly preferred, in which a second housing part which preferably serves as a lower shell has a greater circumferential extent than the first housing part which serves, in particular, as a housing cover (upper shell). In other words, the second shell part is preferably higher than half the diameter of the gearbox housing.

In a development of the invention, there is advantageously provision for the shell parts to be formed from metal. In order to improve the EMC (electromagnetic compatibility) of the motor gearbox unit, it is particularly preferred if the shell parts are formed from a ferromagnetic material, in particular steel sheet.

In order to realize compensation for manufacturing tolerances, one embodiment is particularly preferred, in which the first shell part which serves, in particular, as a housing cover has a smaller wall thickness than the second shell part which preferably serves as a lower shell, and can be deformed resiliently within certain limits as a result. Here, the first shell part is very particularly preferably given substantially no load bearing function. Here, the first shell part can advantageously be bent resiliently in the direction of its circumferential extent.

In order to ensure reliable retention of a pole casing of the electric motor of the motor gearbox unit in the shell housing and in order to make compensation for manufacturing tolerances possible, one embodiment is preferred, in which the pole casing which is configured, in particular, as a pole pot is assigned two adjusting plates which bear laterally against the circumferential face of the pole casing and accommodate the pole casing between them in a clamping manner.

In a development of the invention, there is advantageously provision for the pole casing of the electric motor to be in linear contact with the second shell part, the contact line preferably extending parallel to the longitudinal extent of the pole casing. The linear contact between the pole casing and the second housing part makes it possible for the pole casing to be of particularly short configuration and to be arranged without stress. It is possible as a result of the linear mounting to compensate for any length tolerances between the skeleton motor and the shell part by linear displacement of the holding part/pole casing unit (motor unit). The spatial position of the armature shaft of the skeleton motor is defined unambiguously in relation to the second shell part on account of the linear mounting.

One embodiment of the motor gearbox unit with a holding part which is configured, in particular, as a plastic skeleton is very particularly preferred. Here, the holding part serves to accommodate and/or fix the electric and mechanical components of the electric motor. In contrast to the prior art, it is possible as a result of the realization of a “skeleton motor” to pre-adjust the electromagnetic and mechanical components of the electric motor in a holding part and to integrate said components together with the holding part into the shell housing after the pre-adjustment. In contrast to the prior art, a functional electric motor, in which a performance check is already possible before the final mounting of the motor gearbox unit, is already produced as a result of the pre-adjustment of the electromagnetic and mechanical components of the electric motor before the integration into the housing. The holding part is particularly preferably provided with means which are configured, in particular, as depressions and/or projections and/or latching lugs, etc. for accommodating and/or for holding the pole casing of the electric motor and/or an armature of the electric motor, preferably together with a ball bearing. In addition or as an alternative, means are preferably provided for accommodating and/or holding at least one carbon brush spring lever and/or at least one interference suppression choke and/or a connecting contact, which is configured, in particular, as an insert part, for the voltage supply of the electric motor and/or a clamping clip as axial securing means for the armature. As mentioned, the holding part is preferably configured as a skeleton made from plastic, a skeleton being understood as meaning a framework-like structure with a plurality of cavities which are preferably continuous in the longitudinal direction, are delimited by webs and by way of which the weight of the holding part is reduced. It is particularly preferred if the holding part has two connecting webs which extend in the axial direction and annular sections which are connected to one another, of which a first annular section serves to fix the pole casing and a second annular section serves to fix further motor components, such as the interference suppression choke, etc.

In order to ensure the robustness of the holding part, the cavities are particularly preferably separated from one another by webs which extend, in particular, in the radial direction.

One embodiment is very particularly preferred, in which the pole casing of the electric motor can be fixed on the end side on the holding part which is configured, in particular, as a plastic skeleton, a fully functional electric motor being obtained after fixing of the pole pot, which electric motor merely has to be connected to an electronic power system which can be accommodated in the housing, and which electric motor can be tested before the integration into the housing.

In a development of the invention, there is advantageously provision for the holding part to be provided with a through opening for receiving the armature shaft of the electric motor. As an alternative, the through opening is penetrated by a shaft of the motor gearbox unit, which shaft is coupled to the armature shaft so as to transmit torque. Very particularly preferably, a gear worm for driving a worm gear of the gearbox is arranged on the end side of the armature shaft or the shaft which is coupled to the latter.

One embodiment is particularly expedient, in which the holding part is held in a clamping manner between the shell parts. It is particularly preferred here if the first shell part can be deformed resiliently for the purposes of tolerance compensation.

In a development of the invention, there is advantageously provision for the holding part to have at least one bearing face in the form of a spherical cap for bearing against the housing. Here, a bearing face in the form of a spherical cap is understood as meaning a bearing face, the form of which corresponds to a section of a spherical face. In order to ensure holding of the holding part between the shell parts with an accurate fit, it is preferred if bearing face in the form of a spherical cap of the holding part is mounted (supported) at a plurality of points within the housing which are spaced apart from one another, that is to say at least approximately in a punctiform manner and not over a large area.

One embodiment of the motor gearbox unit can be realized, in which a center point, around which the bearing face in the form of a spherical cap of the holding part extends, lies on the longitudinal center axis of the armature shaft of the electric motor. In order to minimize the outlay on material and the required installation space, one embodiment is preferred, however, in which the center point of the bearing face in the form of a spherical cap is arranged offset relative to the armature shaft longitudinal center axis. One embodiment is very particularly preferred, in which two bearing faces are provided on the holding part, which bearing faces preferably face away from one another, are in the form of a spherical cap and are not curved around a common center point, but rather in each case have a dedicated (imaginary) center point, the center points being spaced apart from one another and particularly preferably being situated on an imaginary axis which intersects the armature shaft longitudinal center axis perpendicularly. Here, the bearing faces preferably have an identical radius to their respective center point.

In order to reliably avoid rotation of the holding part within a housing under load, one embodiment is preferred, in which the holding part is assigned an antirotation safeguard which interacts, in particular in a positively locking manner, with the housing or a component which is connected to the housing.

In wiper motor designs from the prior art, in order to produce both gearbox positions (left hand gearbox position/right hand gearbox position), a plurality of complex individual parts are to be manufactured in each case in a right hand and left hand embodiment—for example, the gearbox cover with electronic power system, the brush carriers and the aluminum die cast gearbox housing. The manufacture of different complex individual parts can be omitted as a result of one development of the invention, according to which the holding part is configured in such a way that it can be arranged in two installation positions in the housing which are preferably offset or rotated around the armature shaft by 180°. In order to realize a mirrored arrangement option of the holding part, one embodiment is preferred, in which the holding part is configured symmetrically with respect to a mirror plane which preferably includes the longitudinal center axis of the armature shaft of the electric motor.

In order to ensure a voltage supply of the electric motor in the two different installation positions, it is possible to provide separate connecting contacts for the two mounting positions. However, one embodiment is particularly preferred, in which the connecting contacts (in particular, contact tabs) can be mounted on the holding part in installation positions which are preferably offset by 180° with respect to one another. The connecting contacts are preferably plug-in parts for plugging into corresponding recesses of the holding part.

In order to ensure optimum mounting or support of the holding part in the housing, one embodiment is preferred, in which at least one part spherical inner face section which is preferably manufactured by stamping is provided on the first and/or second shell part. The part spherical inner face section is preferably formed to be at least approximately congruent to the shape of a bearing face in the form of a spherical cap of the holding part, which bearing face is assigned to said part spherical inner face section.

In order to make it possible to support the holding part on the housing not over a large area, but rather at least approximately in a punctiform manner, it is particularly preferred if a plurality of positioning sections are provided within the part spherical inner face section, which positioning sections are preferably produced by deep drawing, protrude into the housing, are preferably partly spherical, in particular hemispherical, and on which the holding part is supported. Here, the positioning sections are preferably arranged and/or formed in such a way that the bearing face in the form of a spherical cap of the holding part forms an envelope for the positioning sections.

### BRIEF DESCRIPTION OF THE DRAWINGS

Further advantages, features and details of the invention result from the following description of preferred exemplary embodiments and using the drawings, in which:

FIG. 1 shows a perspective, partially sectioned illustration of a detail of the motor gearbox unit, in which the arrangement of the pole casing of the electric motor within the two shell parts of the housing of the motor gearbox unit can be seen,

FIG. 2 shows a perspective view of the housing of the motor gearbox unit, merely with a second housing part,

FIG. 3 shows a perspective illustration of a section of the second shell part, which section is assigned to the gearbox, with a through opening for guiding through an output shaft,

FIG. 4 shows a view from inside of the second shell part before finishing, a part spherical inner face which is manufactured by stamping being realized,

FIG. 5 shows the finished second shell part with positioning sections arranged within the part spherical inner face, in order to realize punctiform mounting of the holding part,

FIG. 6 shows a detail of the second shell part with a holding part accommodated in the former and configured as a plastic skeleton,

FIG. 7 shows a sectional illustration of the motor gearbox unit, from which sectional illustration the arrangement of the skeleton-shaped holding part between the shell parts can be seen,

FIG. 8 shows a perspective illustration of the holding part, from which perspective illustration an end side can be seen which faces the gearbox and has means for fixing electromagnetic and mechanical components of the electric motor,

FIG. 9 shows a clamping clip which can be introduced into a lateral opening of the holding part,

FIG. 10 shows a view of an end side of the holding part, which end side faces the gearbox of the motor gearbox unit,

FIG. 11 shows a perspective view of the holding part,

FIG. 12 shows a view of the holding part, which view is rotated by approximately 90° in comparison with FIG. 11,

FIG. 13 shows a finished electric motor (without electronic power system) before the installation into the common housing of the electric motor and gearbox,

FIG. 14 shows a partially sectioned view of the motor gearbox unit, in which view an antirotation safeguard of the holding part can be seen,

FIG. 15 shows an illustration of the motor gearbox unit with an open housing, without mounted electronic power system,

FIG. 16 shows an illustration of the motor gearbox unit with an open housing, a center point of a bearing face in the form of a spherical cap of the holding part lying on a longitudinal center axis of the armature shaft of the electric motor,

FIG. 17 shows an alternative embodiment of the motor gearbox unit with a center point of the bearing face of the holding part, which center point is spaced apart from the armature shaft,

FIG. 18 shows a partially sectioned, perspective view of the motor gearbox unit with a left hand gearbox position, and

FIG. 19 shows a perspective, partially sectioned illustration of a motor gearbox unit with a right hand gearbox position.

### DETAILED DESCRIPTION

In the figures, identical elements and elements with the same function are labeled with the same designations.

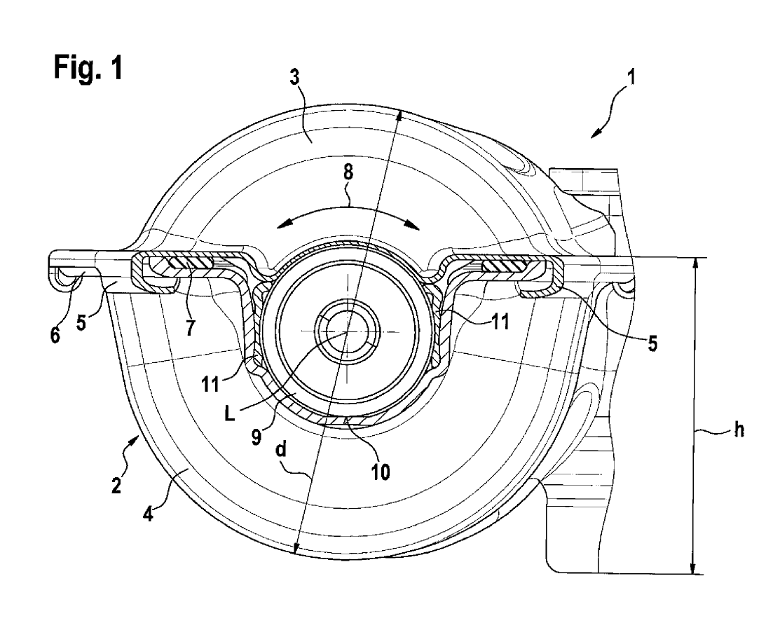

FIG. 1 shows a partially sectioned view of a motor gearbox unit 1 for a pane wiping assembly which is otherwise not shown in greater detail. The motor gearbox unit 1 is provided with a housing 2 which is configured as a two piece shell housing and has a first shell part 3 which serves as housing cover and a second shell part 4 which is connected to the first shell part 3 and is configured as a lower shell for accommodating all the electric motor and gearbox components.

It can be seen from FIG. 1 that the two shell parts 3, 4 are crimped to one another. To this end, the first shell part 3 has edge-side brackets 5 which are arranged so as to engage behind a circumferential fastening flange 6 of the second shell part 4. An annular seal 7 which is configured as a flat seal and ensures the pressure tightness of the housing 2 is situated between the two shell parts 3, 4.

As results further from FIG. 1, the shell parts 3, 4 are configured asymmetrically with respect to one another, the second shell part 4 extending over a greater circumferential angle than the first shell part 3. In other words, the height h of the second shell part 4 is greater than the diameter d of the housing 2. A further difference between the two housing parts 3, 4 comprises the material thickness of the second shell part 4, at least over the majority of the surface extent of the second shell part 4, being greater than the material thickness of the first shell part 3. As a result, the first shell part 3 is elastically deformable within certain limits in the arrow directions 8, that is to say in the direction of its circumferential extent, and therefore makes tolerance compensation possible in a simple way.

The two shell parts 3, 4 are formed from ferromagnetic material, in order to improve the EMC (electromagnetic compatibility) of the electric motor 12 of the motor gearbox unit 1.

Furthermore, it can be seen from FIG. 1 that a pole casing 9 of the electric motor 12, which pole casing 9 is configured as a pole pot, is clamped between the shell parts 3, 4, a linear contact area 10 which is arranged parallel to the longitudinal center axis L of the armature shaft, which longitudinal center axis L extends into the plane of the drawing, being realized between the pole casing 9 and the inner circumference of the second shell part 4.

Two adjusting plates 11 which are arranged approximately parallel to one another and ensure exact alignment and clamping of the pole casing 9 in the housing 2 are situated laterally of the pole casing 9, in a region radially between the pole casing 9 and the second shell part 4.

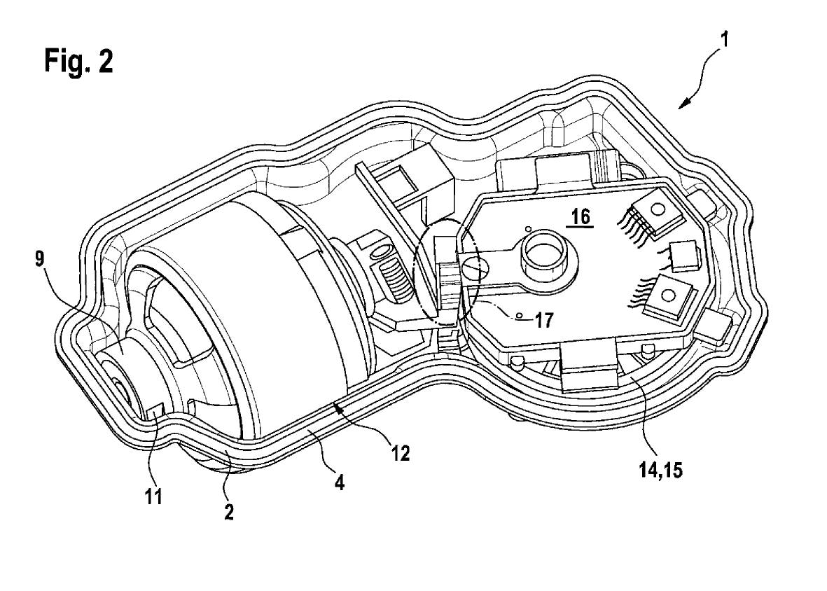

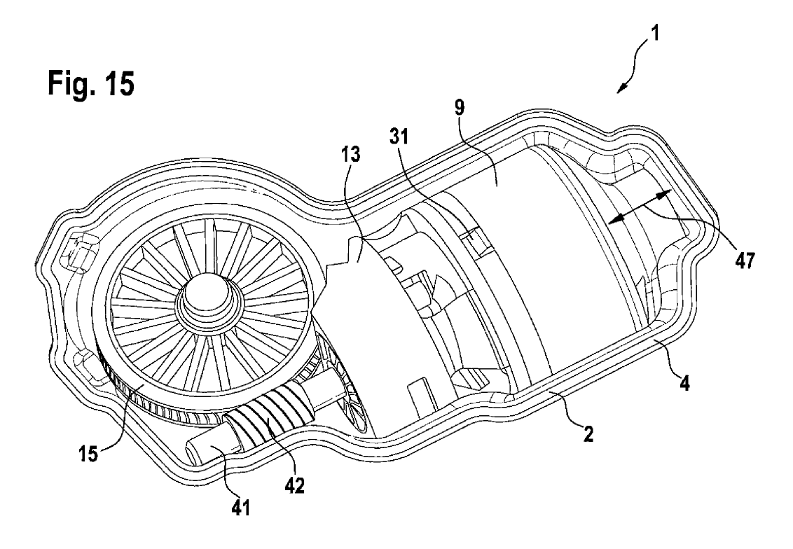

FIG. 2 shows the motor gearbox unit 1 with an opened housing 2, all the functional components of the motor gearbox unit 1 being accommodated within the second shell part 4 which serves as lower shell. For instance, the pole casing 9 of the electric motor 12 is accommodated within the second shell part 4 which is of more rigid configuration than the first shell part 3; the adjusting plates 11 for holding the pole casing 9 can be seen particularly well. The pole casing 9 is fixed to a skeleton-like holding part 13 (not shown) which is made from plastic (cf. FIG. 15) and is arranged in a region between the pole casing 9 and the gearbox 14 of the motor gearbox unit 1, which gearbox 14 is configured as a worm gear mechanism. Furthermore, it can be seen that the gearbox 14 comprises a worm gear 15 which is driven by a gear worm (not shown) and drives an output shaft (not shown) which projects into the plane of the drawing and penetrates a through opening of the second shell part 4. Furthermore, an electronic power system 16 for regulating the electric motor 12 can be seen in FIG. 2, the electronic power system 16 being situated in a region above the worm gear 15. Within the circled region 17, the electronic power system 16 is attached electrically, by welding here, to connecting contacts of the electric motor 12, the connecting contacts being fixed to the holding part which is configured as a plastic skeleton, by being plugged in.

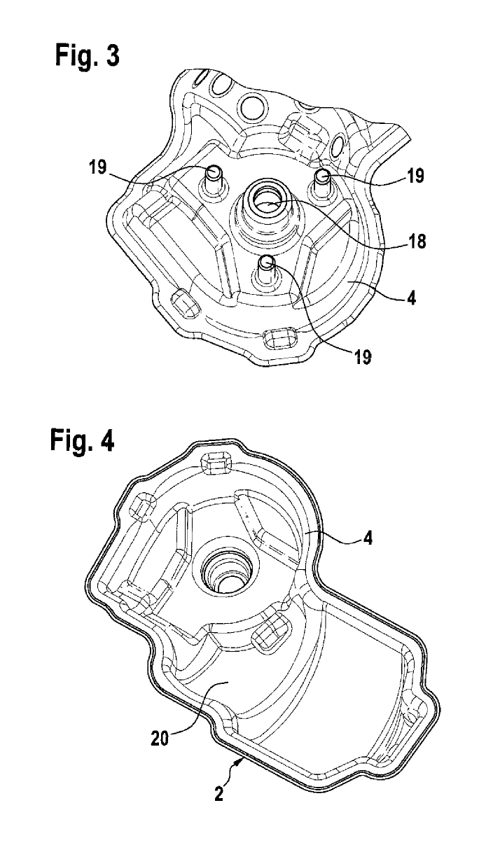

FIG. 3 shows a perspective view from outside of a section of the second shell part 4, which section is assigned to the gearbox 14. A through opening 18 can be seen which, in the finally mounted state, is penetrated by an output shaft (not shown) which is driven by the motor gearbox unit 1. Three stud bolts 19 for connecting the motor gearbox unit 1 to the pane wiper assembly are provided distributed uniformly around the through opening 18 in the circumferential direction.

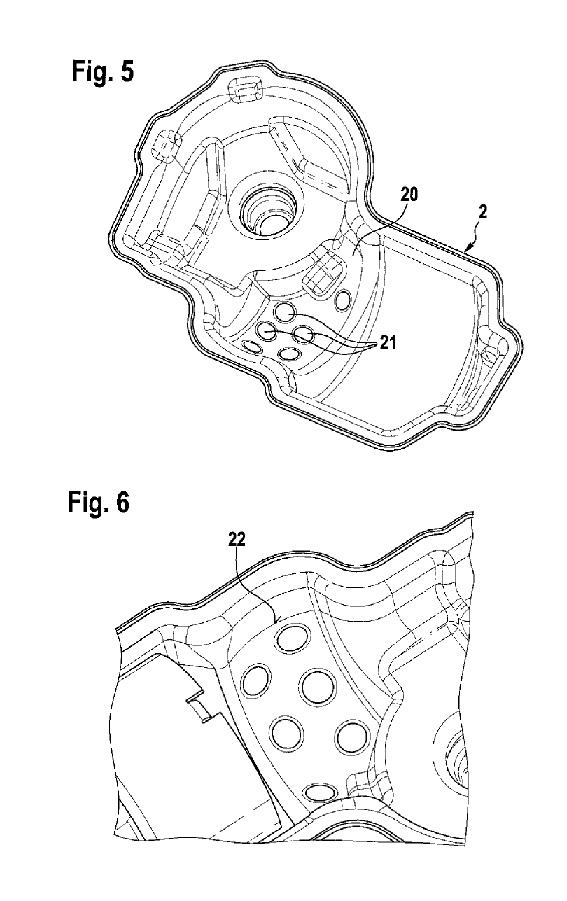

FIG. 4 shows a perspective view from inside of the second shell part 4 in an intermediate stage during production. A region which is assigned to the gearbox 14 can be seen in the plane of the drawing at the top, and a region which is assigned to the pole casing 9 can be seen in the plane of the drawing at the bottom. Furthermore, FIG. 4 shows a part spherical inner face section 20 which is situated in a region between the region which is assigned to the gearbox 14 and the region which is assigned to the pole casing 9. The part spherical inner face section 20 which has the form of a section of a spherical inner face is manufactured by stamping, but does not have sufficient accuracy for reliably supporting the holding part 13, for reasons of manufacturing. In order to ensure reliable holding of the holding part 13 within the housing 2, part spherical positioning sections 21 are made in the part spherical inner face section 20 in a deep drawing manufacturing step which follows the stamping manufacturing step, the positioning sections 21 extending in the radial direction to the inside into the housing 2, starting from the part spherical inner face section 20. As indicated in FIG. 5, the holding part 13 which is configured as a plastic skeleton bears in a punctiform manner against said positioning sections 21 in the mounted state, and can be rotated (easily) and therefore can be aligned more precisely on the positioning sections 21 during mounting, on account of its bearing face 22 in the form of a spherical cap within the part spherical inner face section 20.

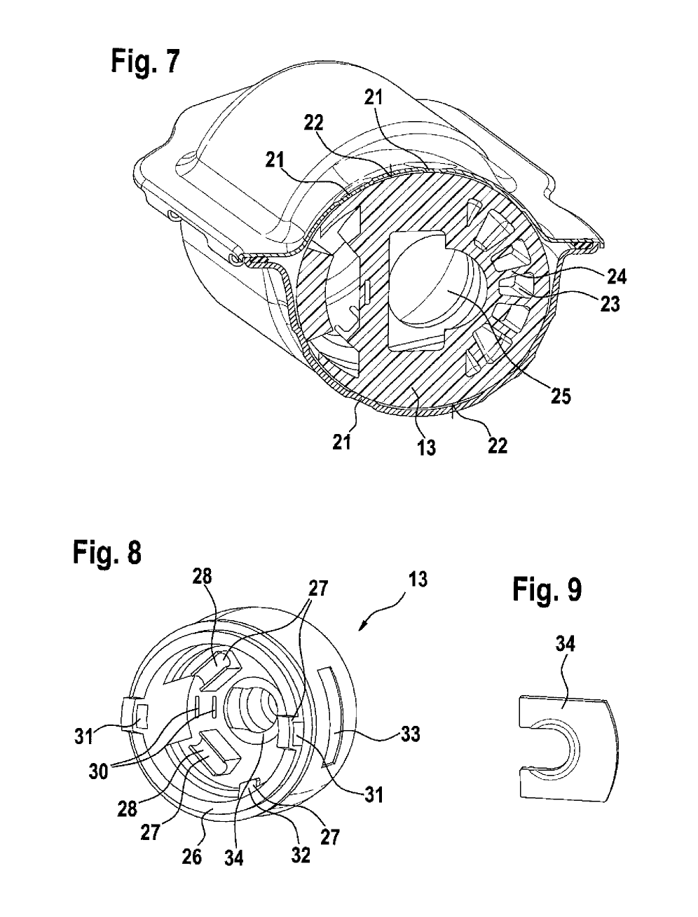

The setpoint position of the holding part 13 (not shown here, but shown, for example, in FIG. 7 and FIG. 15) can be seen in FIG. 6 in a sectional illustration. The holding part 13 which is shown in FIG. 7 and FIG. 15 is received in a clamping manner between the two shell parts 3, 4 and is supported with a bearing face 22 in the form of a spherical cap on the previously mentioned part spherical positioning sections 21 or rests there in a punctiform manner. The holding part 13 is configured as a plastic skeleton with a multiplicity of cavities 23 for weight reduction which extend in the longitudinal direction, the cavities 23 being divided from one another via webs 24 which extend in the radial direction. Here, the holding part 13 is configured as an injection molded part (cf. FIG. 7). Furthermore, it can be seen in FIG. 7 that the holding part 13 has a through opening 25 for guiding through the armature shaft (not shown) of the electric motor.

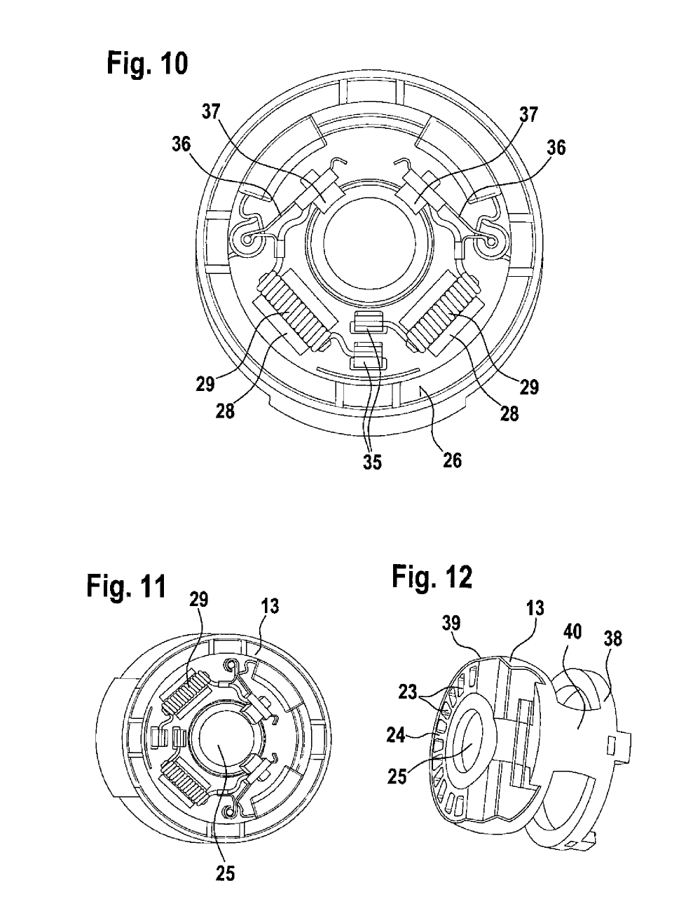

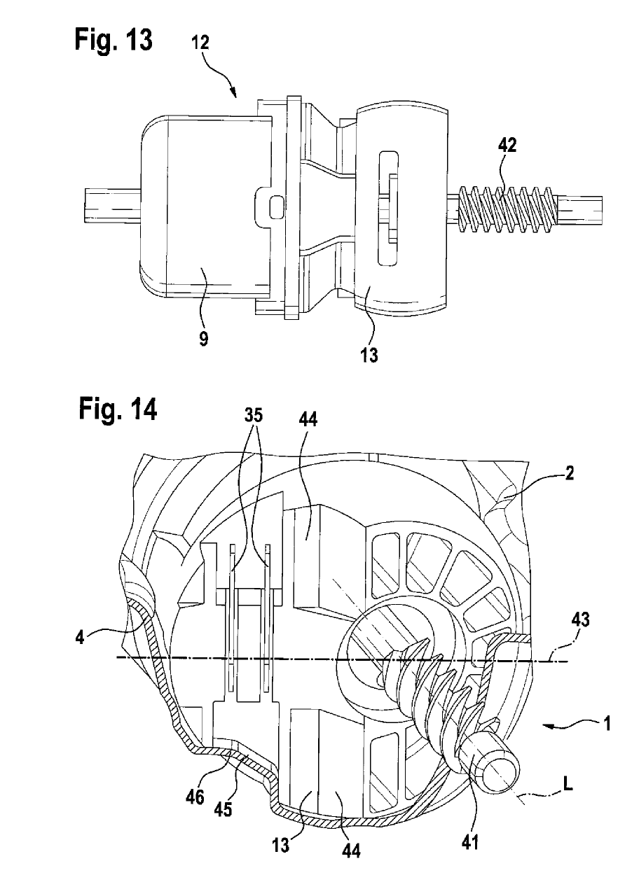

FIG. 8 shows a perspective view of the holding part 13; the end side 26 which faces the gearbox can be seen in FIG. 13. The holding part 13 comprises means 27 for fixing electromagnetic and mechanical components of the electric motor. The means 27 comprise, for example, receptacles 28 for interference suppression chokes 29 (shown in FIG. 10). Furthermore, receptacles 30 are provided for connecting contacts 35 (contact tabs) which are configured as insert parts for connection to the electronic power system. Moreover, receptacles 31 are integrated for fixing the pole casing 9. Furthermore, receptacles 32 are provided for carbon brush spring levers (not shown). The abovementioned parts can be connected in a positively locking manner to the holding part 13, more precisely to the corresponding receptacles 28, 30, 31, 32. Moreover, the means 27 comprise a lateral slot 33 (receptacle) for pushing in a clamping clip 34 (shown in FIG. 9) for axially supporting the armature (not shown) of the electric motor 12 (cf. FIG. 2).

FIG. 10 shows that end side 26 of the holding part 13 which faces the gearbox. The interference suppression chokes 29 (coils) which are latched in a positively locking manner in the receptacles 28 can be seen. The interference suppression chokes 29 connect the connecting contacts 35 to the respectively associated carbon brush spring levers 36. The carbon brush spring levers 36 in each case carry a carbon brush 37 (rubbing contact) which are loaded by spring force in the radial direction to the inside onto the collector (not shown).

FIGS. 11 and 12 show two different perspective views of the holding part 13. The through opening 25 for guiding through the armature shaft can be seen in both views. Furthermore, it can be gathered from FIG. 12 that the holding part 13 has substantially two annular sections 38, 39 which are spaced apart axially from one another, the annular sections 38, 39 being connected to one another via axially extending, parallel webs 40. Here, the cavities 23 which are mentioned in conjunction with FIG. 7 and are bounded by webs 24 are situated in the left hand annular section 39 in the plane of the drawing, which annular section 39 faces the gearbox in the mounted state.

FIG. 13 shows the substantially finally mounted electric motor 12, the pole casing 9 and the skeleton-like holding part 13, on which the pole casing 9 is held. The pole casing 9 and the holding part 13 are penetrated by an armature shaft 41 which carries a gear worm 42 in an end region.

The skeleton-like holding part 13 which is inserted into the second shell part 4 and in which the connecting contacts 35 which are configured as insert parts are mounted can be seen in a perspective, partially sectioned view of the motor gearbox unit 1 in FIG. 14. Furthermore, it can be seen that the holding part 13 is of mirror symmetrical configuration with respect to an imaginary mirror plane 43 (plane of symmetry) which includes the longitudinal center axis L of the armature shaft 41. The symmetrical configuration of the holding part 13 makes mounting in a correspondingly adapted second shell part possible in the installation position shown and in an installation position which is rotated with respect to the latter by 180°. Furthermore, receptacles 44 which are arranged on the end side for the electronic power system (not shown in FIG. 14) of the electric motor 12 can be seen.

Furthermore, an antirotation safeguard 45 can be seen in FIG. 14, which antirotation safeguard 45 is configured as a lateral recess in the holding part 13, into which lateral recess a dimensionally congruent, radially inwardly directed indentation 46 of the metallic, second shell part 4 protrudes in a positively locking manner and therefore secures the holding part 13 against rotation within the housing 2.

The motor gearbox unit 1 with an opened housing 2 can be seen in an incomplete illustration in FIG. 15. Here, the interaction of the armature shaft 41 and the gear worm 42 with the worm gear 15 becomes clear, which worm gear 15 is in turn connected in a positively locking manner to an output shaft (not shown) which projects into the plane of the drawing. As results from FIG. 15, furthermore, the pole casing 9 is latched with the holding part 13 and engages with corresponding latching lugs into the edge-side receptacles 31 of the holding part 13 in a positively locking manner. It can be gathered from FIG. 15 that the pole casing 9 with an end-side sintered bearing received in it is displaceable during mounting within certain limits in arrow directions 47, in order thus to ensure tolerance compensation.

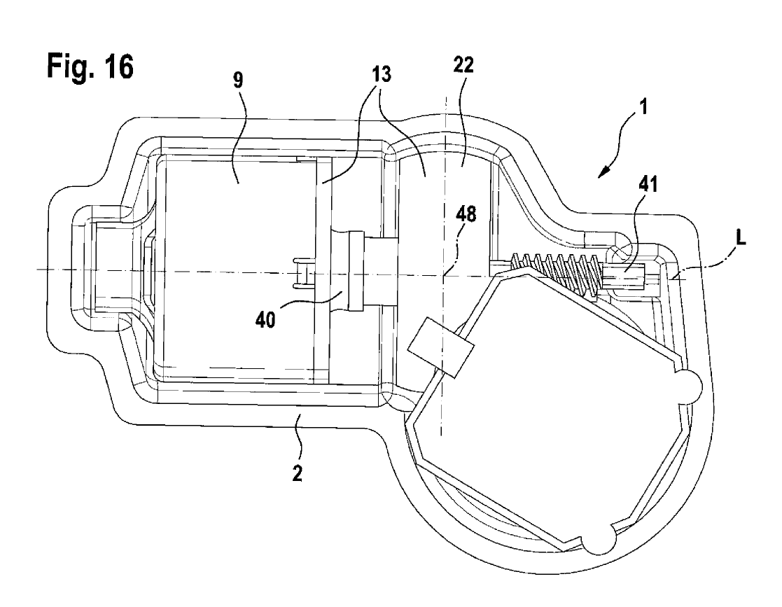

FIG. 16 shows the motor gearbox unit 1 with an opened housing 2. In FIG. 16, the longitudinal center axis L of the armature shaft 41 is illustrated, on which longitudinal center axis L a center point 48 lies, around which the bearing face 22 in the form of a spherical cap of the holding part 13 is defined.

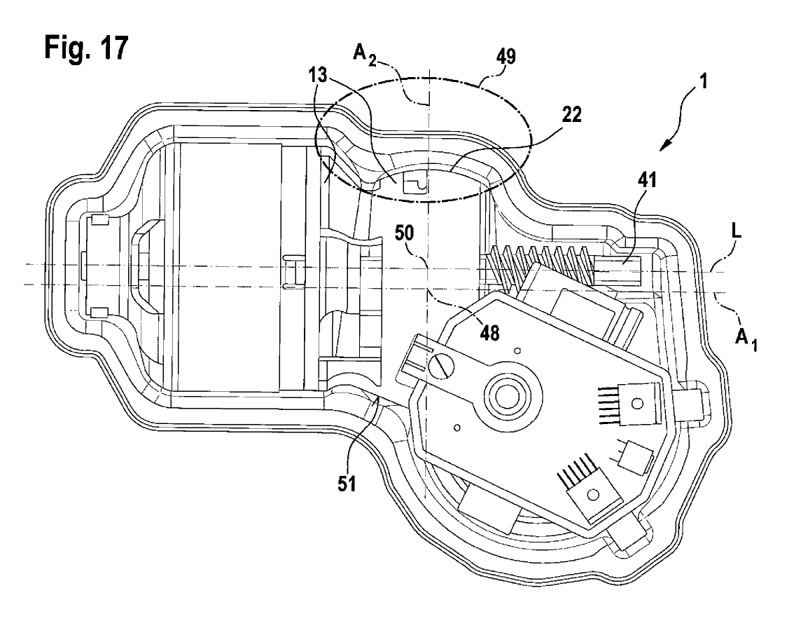

FIG. 17 shows an alternative embodiment to this. In said figure, the longitudinal center axis L of the armature shaft 41 is once again illustrated. It can be seen that the center point 48 of the bearing face 22 in the form of a spherical cap is displaced to the bottom in the plane of the drawing in the direction of the gearbox and is therefore arranged at a spacing from the armature shaft 41. The center point 48 is situated on an imaginary axis A₁ which is parallel to the longitudinal center axis L. As a result, installation space is saved in a circled region 49 in comparison with the exemplary embodiment according to FIG. 16. A further center point 50 of a bearing face 22 in the form of a spherical cap which faces away from the bearing face 51 in the form of a spherical cap is situated directly on the longitudinal center axis L at a spacing from the above-mentioned center point 48, the two center points 48, 51 being arranged on an axis A₂ which intersects the longitudinal center axis L perpendicularly.

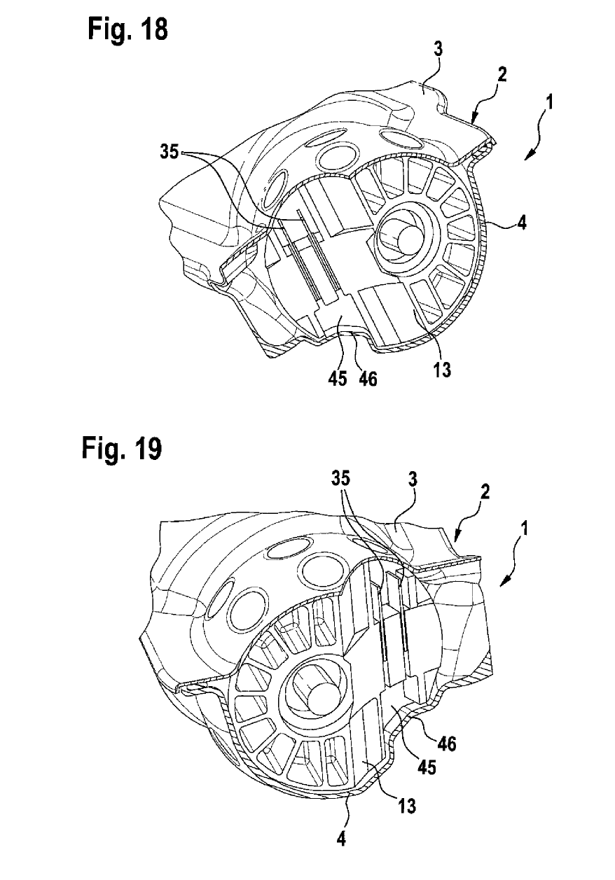

FIGS. 18 and 19 show two different installation positions of the holding part 13 which are rotated by 180°. In FIG. 18, the holding part 13 is accommodated in a housing 2 which is configured for a left hand gearbox position, whereas the holding element 13 in FIG. 19 is accommodated in a housing 2 which is formed for a right hand gearbox position. As results from a comparison of FIGS. 18 and 19, the connecting contacts 35 are fixed on the holding part 13 in different installation positions in the two installation positions, to be precise in holding positions which are offset by 180° with respect to one another, in order to make contact with the electronic power system possible. As results, furthermore, from a comparison of FIGS. 18, 19, the clearance (cutout) which is used by the connecting contacts 35 in the respectively other installation position is used as an antirotation safeguard 45 which interacts with an indentation 46 of the second shell part 4 in a positively locking manner.

1. A motor gearbox unit comprising: an electric motor (12), a gearbox (14) which is driven by the electric motor (12), and a housing (2), wherein the housing (2) is configured as a shell housing which accommodates both the electric motor (12) and the gearbox (14) and comprises a first and a second shell part (3, 4) characterized in that the first shell part (3) has a smaller wall thickness than the second shell part (4) and can be deformed resiliently.

2. The motor gearbox unit as claimed in claim 1, characterized in that the shell parts (3, 4) are shaped differently such that the first shell part (3), which serves as a housing cover, extends over a smaller circumferential angle than the second housing part (4).

3. The motor gearbox unit as claimed in claim 1, characterized in that the shell parts (3, 4) are formed from metal.

4. (canceled)

5. The motor gearbox unit as claimed in claim 1, characterized in that at least one adjusting plate (11) is provided for clamping a pole casing (9) of the electric motor (12), which pole casing (9) is accommodated in the housing (2) and is configured as a pole pot.

6. The motor gearbox unit as claimed in claim 5, characterized in that the pole casing (9) of the electric motor (12) is arranged in linear contact with the second shell part (4).

7. The motor gearbox unit as claimed in claim 1, characterized in that a holding part (13) is provided which is configured as a plastic skeleton and has means (27) for accommodating at least one of a pole casing (9) of the electric motor (12), an armature, at least one carbon brush spring lever (36), at least one interference suppression choke (29), and at least one connecting contact (35) which is configured as an insert part for at least one of a voltage supply and clamping clip (34).

8. The motor gearbox unit as claimed in claim 7, characterized in that the holding part (13) has a through opening (18, 25) for guiding through one of an armature shaft (41) and a shaft which is coupled to the armature shaft (41) so as to transmit torque.

9. The motor gearbox unit as claimed in claim 7, characterized in that the holding part (13) is held in a clamping manner between the shell parts (3, 4).

10. The motor gearbox unit as claimed in claim 7, characterized in that the holding part (13) has at least one bearing face (22, 51) which is in the form of a spherical cap for bearing against the housing (2).

11. The motor gearbox unit as claimed in claim 10, characterized in that the spherical cap face is spaced apart at a radius from a center point (48, 50) which is arranged at a spacing from a longitudinal center axis (L) of an armature shaft (41) of the electric motor (12).

12. The motor gearbox unit as claimed in claim 10, characterized in that two bearing faces (22, 51) are provided on the holding part (13), which bearing faces (22, 51) preferably point in different directions, are each in the form of a spherical cap and are each spaced apart at a radius from a respective center point (48, 50), and in that the center points (48, 50) of the bearing faces (22, 51) are spaced apart from one another.

13. The motor gearbox unit as claimed in claim 7, characterized in that an antirotation safeguard (45) which interacts with the housing (2) is provided on the holding part (13).

14. The motor gearbox unit as claimed in claim 7, characterized in that the holding part (13) can be arranged in two installation positions in the housing (2) which are preferably offset by 180° with respect to one another.

15. The motor gearbox unit as claimed in claim 7, characterized in that the at least one connecting contact (35) for the voltage supply of the electric motor (12) can be mounted in two different installation positions on the holding part (13) which are preferably offset by 180° with respect to one another.

16. The motor gearbox unit as claimed in claim 1, characterized in that at least one partially spherical inner face section (20) is provided on at least one of the first and second shell part (3, 4) of the housing (2).

17. The motor gearbox unit as claimed in claim 16, characterized in that a plurality of positioning sections (21) for realizing punctiform mounting of the holding part (13) are provided within the partially spherical inner face section (20), which positioning sections (21) protrude into the housing (2) and are partially spherical.

18. (canceled)

19. The motor gearbox unit as claimed in claim 1, wherein the motor gearbox unit is part of a pane wiping assembly of a motor vehicle.

20. The motor gearbox unit as claimed in claim 3, characterized in that the shell parts (3, 4) are formed from steel sheet.

21. The motor gearbox unit as claimed in claim 10, characterized in that the spherical cap is mounted in a punctiform manner.
